(19) United States
(12) Patent Application Publication
(10) Pub. No.: US 2006/0240191 A1
(43) Pub. Date: Oct. 26, 2006

(54) Composition and process for preparing chromium-zirconium coatings on metal substrates

(75) Inventors: Craig A. Matzdorf, California, MD (US); William C. Nickerson JR., Hughesville, MD (US); James L. Green, Lusby, MD (US)

Correspondence Address: NAVAL AIR WARFARE CENTER AIRCRAFT;DIVISION OFFICE OF COUNSEL BLDG 435, SUITE A, 47076 LILJENCRANTZ ROAD UNIT 7, PATUXENT RIVER, MD, 20670, US

(73) Assignee: The U.S. of America as represented by the Secretary of the Navy

(21) Appl. No.: 11/116,166

(22) Filed: Apr. 21, 2005

(51) Int. Cl. B05D 3/00; C04B 9/02; C23C 22/00; C23C 22/48

(52) U.S. Cl. 427/299; 148/243; 148/247; 106/14.13; 106/14.44; 106/14.21

(57) ABSTRACT

This invention comprises an acidic aqueous solution for treating metal substrates to improve the adhesion bonding and corrosion protection which comprises effective amounts of water soluble trivalent chromium compounds, fluorozirconates, fluorometallic compounds, zinc compounds, thickeners, surfactants, and at least about 0.001 mole per liter of the acidic solution of at least one polyhydroxy and/or carboxylic compound as the stabilizing agent for the aqueous solution.

### ORIGIN OF INTION

The invention described herein was made by employee(s) of the United States Government and may be manufactured and used by or for the Government for governmental purposes without the payment of any royalties thereon or therefor.

### CONTINUATION APPLICATION

This application is a Continuation-In-Part of copending Application Serial No. NC-96,346, Filed: Feb. 15, 2005.

### BACKGROUND OF THE INVENTION

### Field of the Invention

This invention relates to compositions and to a process for using said compositions for preparing chromium-zirconium coatings on various metal substrates. The process comprises treating the metal substrates with effective amounts of an acidic aqueous solution containing at least one trivalent chromium compound, at least one fluorozirconate, at least one carboxylic compound, and/or at least one polyhydroxy compound, and optionally effective amounts of fluorometallic compounds including compounds such as fluorotitanates, fluorotantalates, fluoroborates, fluorosilicates, divalent zinc compounds, surfactants, wetting agents and/or thickeners. More specifically, this invention relates to stable acidic aqueous solutions and the process for treating various metal substrates including pre-coated metal substrates to improve the substrates adhesion bonding and corrosion-resistant properties. The process comprises treating the metal substrates with a stable acidic aqueous solution containing effective amounts of at least one water-soluble trivalent chromium compound, at least one water soluble fluorozirconate, and at least one water soluble carboxylic compound and/or polyhydroxy compound. In addition, other compounds that can be added to the acidic solutions in small but effective amounts include at least one water soluble fluorometallic compound, divalent zinc compounds, and effective amounts of water soluble thickeners and/or water soluble surfactants.

This invention comprises a range of aqueous solutions or compositions of specific chemicals and to the processes for depositing coatings derived from these chemicals onto a variety of metallic substrates including pre-existing metal coated substrates. For example, the compositions or solutions can be utilized for coating aluminum and aluminum alloy conversion coatings to enhance corrosion protection and paint adhesion; for sealing anodic coatings to enhance its corrosion protection; for treatment of titanium and titanium alloys for enhanced paint adhesion; for treatment of magnesium alloys for enhanced paint adhesion and corrosion protection; for coating steel for enhanced paint adhesion and rust inhibition; and for post-treatment of phosphate coatings, aluminum, zinc, zinc-nickel, tin-zinc, titanium and cadmium sacrificial coatings on iron alloys and other metal substrates e.g. steel for enhanced paint adhesion and corrosion protection.

Many of the current pretreatment, post-treatment and sealer solutions are based on the use of hexavalent chromium chemistry. Hexavalent chromium is highly toxic and a known carcinogen. As a result, the solutions used to deposit these coatings and the coatings per se are toxic. These films or coatings do, however, yield outstanding paint adhesion, good corrosion resistance, low electrical resistance and can be easily applied by immersion, spray or wipe-on techniques. However, the environmental laws, executive orders, and local occupational, safety, and health (OSH) regulations are driving the military and the commercial users in search for alternatives. Moreover, the use of hexavalent chromium coatings is becoming more expensive as regulations tighten and costs become prohibitive with future PEL restrictions imposed by the EPA and OSHA. In addition, certain processes like spraying chromate solutions are forbidden at some facilities due to OSH risk, forcing the use of less than optimum alternative solutions. In summary, hexavalent chromate coatings are technically outstanding, but from a life-cycle cost, environmental, and OSH perspective, alternatives are highly desirable. Accordingly, research is underway to develop alternative processes for metal finishing that are technically equivalent or superior to hexavalent chromate coatings without the environmental and health drawbacks.

Many of these alternatives, however, regardless of composition and methods of application, have a tendency to precipitate solid material from solution especially after heavy usage. This precipitation can, over time, weaken the effectiveness of the coating solution as the active compounds precipitate as insoluble solids. Additionally, the solid precipitations have the potential to clog filters, lines, and pumps for both the immersion and spray applications. Therefore, better compositions are needed to stabilize the acidic solutions for storage and process applications that will not interfere with the deposition process or the subsequent performance of the deposited coating.

### SUMMARY OF THE INVENTION

This invention relates to compositions and processes for preparing corrosion-resistant coatings on various metallic substrates including pre-coated metal substrates such as phosphate coatings or anodized coatings which comprises treating the substrates with an acidic aqueous solution comprising trivalent chromium III compounds, fluorozirconates, and stabilizing compounds; and optionally one or more fluorometallic compounds, surfactants, thickeners, and divalent zinc compounds. This invention can be utilized to improve the adhesion of coatings such as paint to the metal surface and to improve the corrosion-inhibiting properties of metal surfaces such as aluminum, steel, galvanized surfaces and the like. The acidic solutions of this invention also comprises an effective amount of at least one water-soluble stabilizing agent or compound consisting of polyhydroxy compounds and/or water-soluble carboxylic compounds containing one or more carboxylic functional groups having the formula R—COO— wherein R is hydrogen or a lower molecular weight organic radical or functional group. The stabilizers i.e. the carboxylic compounds can be used in the form of their acids or salts. In some cases the salts of the carboxylic stabilizers perform better than their acids. For example, formic, acetic, glycolic, propionic, citric and other short-chain or low molecular weight carboxylic acids that naturally buffer in the mildly acidic pH range can be utilized as the acidic solution stabilizers. The advantage of adding the polyhydroxy or carboxylic stabilizers to the acidic solution is the improved shelf-life and working stability of the solutions. The acidic solutions with the addition of the stabilizing agents had substantially no precipitation after more than twenty-four months of shelf-life evaluation and without any degradation of the as-deposited coating performance. FIGS. 1-6 show the improved performance of aluminum alloys coated with the composition described by this invention in comparison to conventional coatings without the stabilizing compounds.

It is therefore an object of this invention to provide a stable acidic aqueous solution comprising trivalent chromium compounds, fluorozirconates, polyhydroxy compounds and/or carboxylic compounds for coating metal substrates including pre-coated substrates to improve the adhesion and corrosion-resistance properties.

It is another object of this invention to provide a stable acidic aqueous solution having a pH ranging from about 1.0 to 5.5 which comprises trivalent chromium compounds, fluorozirconates and at least one polyhydroxy compound and/or carboxylic compound for treating metal substrates with or without a pre-existing coating.

It is another object of this invention to provide a process for treating metal substrates to provide a coating with an identifiable color, good adhesion and improved corrosion resistance.

It is a further object of this invention to provide a stable acidic aqueous solution having a pH ranging from about 1.0 to 5.5 comprising trivalent chromium compounds, hexafluorozirconates and at least one carboxylic and/or polyhydroxy compound for treating metal substrates at ambient temperatures or higher wherein said acidic solution contains substantially no hexavalent chromium.

These and other object of the invention will become apparent by reference to the detailed description when considered in conjunction with the accompanying FIGS. 1 to 6, (photos).

### DESCRIPTION OF THE DRAWINGS

FIG. 1 (photo) shows the corrosion performance of an aluminum alloy (AA2024T3) panel with the conversion coating derived from a composition (TCP/R—COO—) as Example 4 of this invention. The bottom of the panel was not treated.

FIG. 2 (photo) shows the corrosion performance of an aluminum alloy (AA2024T3) panel with a conversion coating derived from a conventional composition (TCP) without a (R—COO—) carboxylic stabilizer. The bottom of the panel was not treated.

FIG. 3 (photo) shows the corrosion performance of an aluminum alloy (AA7075T6) panel with a conversion coating derived from a composition (TCP/R—COO—) as Example 4 of this invention. The bottom of the panel was not treated.

FIG. 4 (photo) shows the corrosion performance of an aluminum alloy (AA7075T6) panel with a conversion coating derived from a conventional composition (TCP) without a (R—COO—) carboxylic stabilizer. The bottom of the panel was not treated.

FIG. 5 (photo) shows the corrosion performance of an aluminum alloy panel with a coating derived from an acidic aqueous solution (pH 3.55) of this invention containing 0.1 mole of glycerol per liter of solution after 25 days in neutral salt fog.

FIG. 6 (photo) shows the corrosion performance of an aluminum alloy panel with a coating derived from an acidic aqueous solution (pH 3.90) of this invention containing 0.1 mole of glycerol per liter of solution after 25 days in a neutral salt fog. The bottom of panels (FIGS. 5 and 6) were not treated.

### DETAILED DESCRIPTION OF THE INVENTION

This invention relates to stable acidic aqueous solutions and to the process of using said aqueous solutions having a pH ranging from about 1.0 to 5.5, and preferably from about 2.5 to 4.5 or 3.4 to 4.0 for preparing zirconium-chromium coatings such as conversion coatings on metal substrates including, for example, pre-coated substrates e.g. anodized aluminum or phosphate coated substrates to improve adhesion bonding and the corrosion-resistance properties of the metal. Phosphate coatings include any coatings known in the art including, for example, zinc phosphate coatings, iron phosphate, manganese phosphates and mixed calcium-zinc phosphate coatings. The process comprises using the acidic aqueous solution at temperatures ranging up to about 120° F. or higher e.g. up to about 200° F. which comprises from about 0.01 to 100 grams and preferably from about 0.01 to 22 or 5.0 to 7.0 grams per liter of acidic solution of at least one water soluble trivalent chromium compound e.g. chromium sulfate, about 0.01 to 24 grams and preferably about 1.0 to 12 or 1.0 to 6.0 grams per liter of solution of at least one fluorozirconate e.g. an alkali metal salt of H₂ZrF₆, and from about 0.001 to 2.0 and preferably 0.001 to 1.0 or 0.01 to 0.2 moles per liter of the solution of at least one water-soluble stabilizing agent or compounds selected from the group consisting of carboxylic compounds, polyhydroxy compounds and mixtures of these stabilizing compounds in any ratio. If needed, each of the compounds of this invention can be used up to their solubility limits in the acidic aqueous solutions depending on the metal substrate being treated.

The metal surfaces treated in accordance with the present invention may be any metal substrate including, for example, iron, zinc, magnesium, steel surfaces, including galvanized steel, aluminum or alloys thereof. Virtually any metal surface, including metal surfaces containing a protective metal coating may be treated with the compositions of the present invention.

After cleaning and deoxidizing or pickling the metal substrate e.g. aluminum substrate via conventional mechanical or chemical techniques, the acidic solution of this invention is applied at about room temperature to the metal substrate via immersion, spray or wipe-on techniques similar to the process used for metal treatments. Solution dwell time ranges from about 1.0 to 60 minutes. With this solution, the 1.0 to 40 or 1.0 to 10 minute dwell time yields an optimum film for color change, paint adhesion, and corrosion resistance. The 1.0 to 10 minute dwell time yields appreciable color change to the coating depending primarily on the chemical composition of the aqueous solution. The remaining unreacted solution is subsequently rinsed from the metal substrate with tap or deionized water.

In some processes, depending on the physical characteristics of the metal substrate e.g. the physical size of the steel or aluminum substrates, the addition of a thickener to the solution aids in optimum film formation during spray and wipe-on applications by slowing down solution evaporation. This mitigates the formation of powdery deposits that degrade paint adhesion. The addition of thickeners, also aids in proper film formation during large area applications and mitigates the diluent effect of rinse water that remains on the substrate during processing from previous steps. This feature of the process yields films or coatings that have no streaks and are an improvement in coloration and corrosion protection. Water-soluble thickeners such as the cellulose compounds can be present in the acidic aqueous solution in amounts ranging from about 0.0 to 20 grams per liter and preferably 0.5 to 10 grams e.g., about 0.1 to 5.0 grams per liter of the aqueous solution. Further, depending on the characteristics of the metal substrates, an effective but small amount of at least one water-soluble surfactant or wetting agent can be added to the acidic solution in amounts ranging from about 0.0 to 20 grams and preferably from 0.5 to 10 grams e.g. 0.1 to 5.0 grams per liter of the acidic solution. There are many water soluble surfactants known in the prior art and therefore for purpose of this invention the surfactants can be selected from the group consisting of non-ionic, cationic and anionic surfactants.

The trivalent chromium is added to the solution as a water-soluble trivalent chromium compound, either as a liquid or solid and preferably as a trivalent chromium salt. Specifically, in formulating the acidic aqueous solutions of this invention, the chromium salt can be added conveniently to the solution in its water soluble form wherein the valence of the chromium is plus 3. For example, some of the preferred chromium compounds are incorporated in the solution in the form of Cr₂(SO₄)₃, (NH₄)Cr(SO₄)₂, Cr(NO)₃-9H₂O or KCr(SO₄)₂ and any mixtures of these compounds. A preferred trivalent chromium salt concentration is within the range of about 5.0 to 7.0 grams per liter of the aqueous solution. It has been found that particularly good results are obtained from these processes when the trivalent chromium compound is present in solution in the preferred ranges.

The acidic solutions may contain at least one divalent zinc compound to provide color and improve corrosion protection of the substrate when compared to other treatments or compositions that do not contain zinc. The amount of the zinc compounds can be varied to adjust the color imparted to the coating, from 0.0 to 20 grams to as little as about 0.001 grams per liter up to 10 grams per liter e.g. 0.5 to 2.0 grams of Zinc²+cation. The divalent zinc can be supplied by any chemical compound e.g. salt that dissolves in water at the required concentration and is compatible with the other components in the acid solution. Divalent zinc compounds that are water soluble at the required concentrations preferably include, for example, zinc acetate, zinc telluride, zinc tetrafluoroborate, zinc molybdate, zinc hexafluorosilicate, zinc sulfate and the like or any combination thereof in any ratio. The treatment or coating of the metal substrates can be carried out at various temperatures including temperatures of the solution which ranges from ambient e.g. from about room temperature up to about 120° F. or higher up to about 200° F. Room temperature is preferred, however, in that this eliminates the necessity for heating equipment. The coating may be air dried by any of the methods known in the art including, for example, oven drying, forced-air drying, exposure to infra-red lamps, and the like.

The following Examples illustrate the stable acidic solutions of this invention, and the method of using the solutions in providing color recognition, improved adhesion bonding and corrosion-resistant coatings for metal substrates including metal substrates having pre-existing metal coatings.

### EXAMPLE 1

A stable acidic aqueous solution having a pH ranging from about 3.4 to 4.0 for treating metal substrates to provide a corrosion-resistant and a color recognized coating thereon comprises, per liter of solution, about 3.0 grams of trivalent chromium sulfate basic, about 4.0 grams of potassium hexafluorozirconate, about 1.0 gram of zinc sulfate and about 0.2 mole per liter of solution of an alkali metal salt of formic acid.

### EXAMPLE 2

A stable acidic aqueous solution for coating steel substrate to form a corrosion-resistant coating thereon comprises, per liter of solution, about 3.0 grams of trivalent chromium sulfate basic, about 4.0 grams of potassium hexafluorozirconate, and 0.2 moles per liter of solution of an alkali metal salt of citric acid.

### EXAMPLE 3

A stable acidic aqueous solution for coating steel substrate to provide a corrosion-resistant and a color recognized coating thereon comprising, per liter of solution, about 3.0 grams of trivalent chromium sulfate basic, about 4.0 grams of potassium hexafluorozirconate, about 2.0 grams of divalent zinc sulfate and about 0.001 mole per liter of solution of formic acid.

### EXAMPLE 4

An improved acidic stabilizer solution was prepared from about 4.0 grams per liter of potassium hexafluorozirconate, about 3.0 grams per liter of basic chromium (III) sulfate, and about 0.01 mole per liter of potassium formate. After about 30 days, the pH of the solution was 3.96. After about 12 months, the pH of the solution was 3.92.

### EXAMPLE 4A

An improved acidic stabilizer solution was prepared from about 4.0 grams per liter of potassium hexafluorozirconate, about 3.0 grams per liter of basic chromium (III) sulfate, and about 0.1 mole per liter of glycerol.

### EXAMPLE 5

A solution having from about 0.01 to 10 grams per liter of potassium hexafluorozirconate, from about 0.01 to 10 grams per liter of basic trivalent chromium sulfate, from about 0.0 to 10 grams per liter of a water-soluble surfactant, from about 0.0 to 10 grams per liter of methyl cellulose thickener, from about 0.0 to 5.0 grams per liter of a divalent zinc compound, and from about 0.001 to 0.2 mole per liter of a water-soluble carboxylic acid salt.

### EXAMPLE 6

The solution of Example 5, wherein the potassium hexafluorozirconate is 4.0 grams per liter, the basic chromium sulfate is 3.0 grams per liter, the divalent zinc compound ranges from 0.05 to 2.0 grams per liter, and the water-soluble carboxylic acid salt ranges from 0.005 to 0.01 mole per liter and from 0.0 to 10 grams per liter of a water-soluble surfactant, from 0.0 to 10 grams per liter of a methyl cellulose thickener.

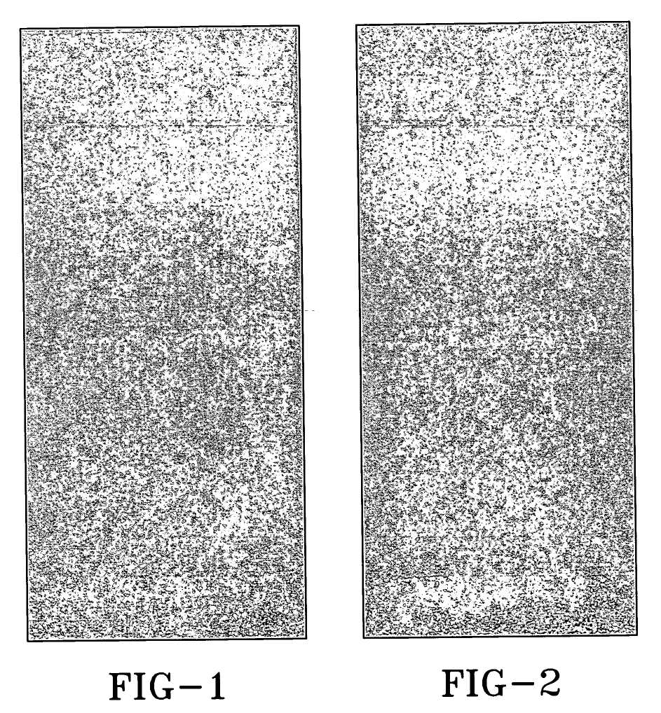

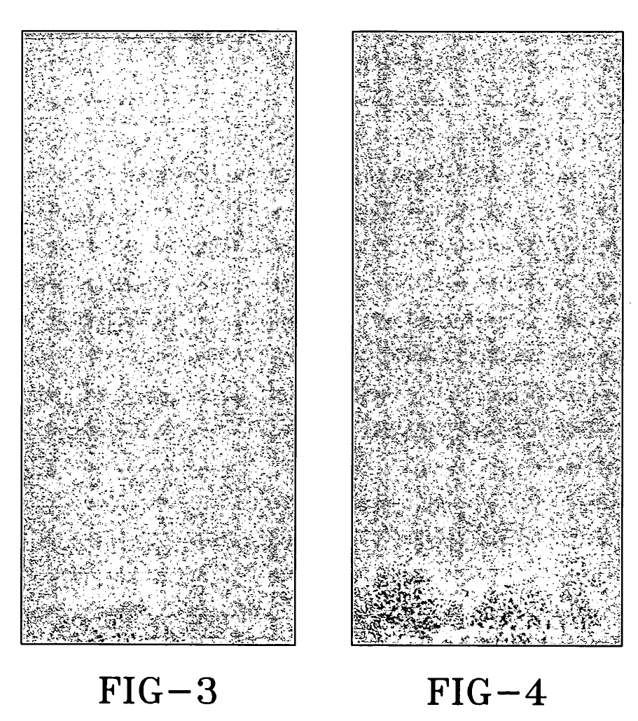

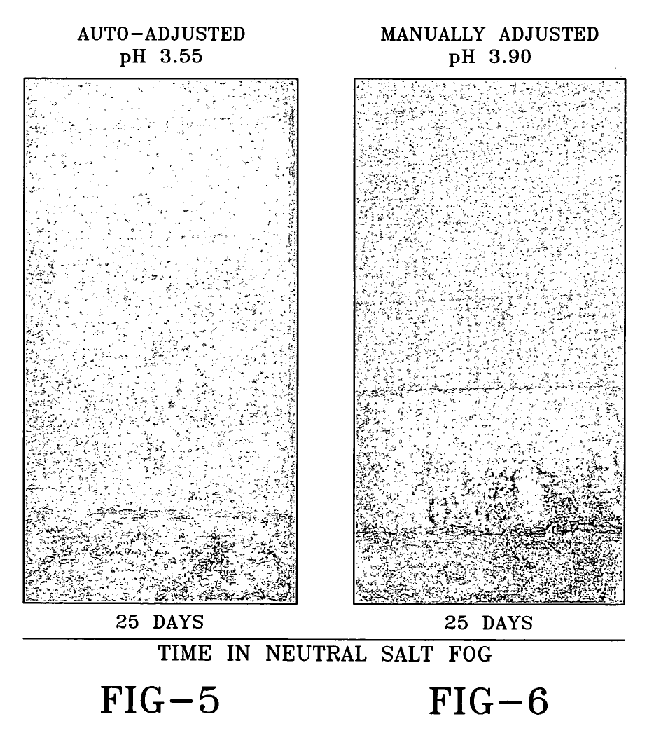

The photos (FIGS. 1-4) show the corrosion and pH data of aluminum panels with and without stabilizers in the comparative solutions. The metal substrates (AA2024T3) were cleaned for about 15 minutes in non-silicated mild alkaline chemistry, deoxidized for about 5 minutes with ferrous-based chemistry and treated in TCP for about 5 minutes. The panels were then placed in ASTM B117 exposure salt fog. The bottoms of the panels, FIGS. 1 and 2 (AA2024T3), were not treated to demonstrate the performance of the bare metal in comparison to the conversion-coated aluminum panels treated with a solution as Example 4 of this invention. Metal substrates (AA7075T6) were cleaned for about 15 minutes in non-silicated mild alkaline chemistry, deoxidized for about 5 minutes with ferrous-based chemistry and treated in TCP for about 5 minutes. The panels were then placed in ASTM B117 exposure salt fog. Again, the bottom of the panels, FIGS. 3 and 4 (AA7075T6), were not treated to demonstrate the corrosion of the bare metal in comparison to the the conversion-coated aluminum panels treated with a solution as Example 4 of this invention. The term “salt fog” is the salt spray corrosion-resistance test set forth in ASTM-B117-61.

The stabilizing carboxylic compounds include water-soluble acids and/or carboxylic acid salts, including the water-soluble carboxylic acids and salts such as adipic, citric, acetic, citraconic, fumaric, glutaric, tartaric acids, ethylenediamine tetraacetic acid and the like provided the hydrocarbon chain on the carboxylic group does not contain a significant number of carbons which decrease the compounds degree of solubility. Combinations of two or more of the salts and/or acids can be used to obtain a specific pH. For example, the lower molecular acids and/or salts such as potassium formate or citrate at concentrations of at least 0.001 to 1.0 mole per liter are good all-around stabilizers. Particularly good results were obtained from acidic solutions prepared by adding about 0.01 mole per liter of potassium formate after 4 days of the initial solution preparation. Good results are obtained if the stabilizing agents are carboxylic compounds containing both hydroxy and carboxylic groups including, for example, compounds such as citric acid, glycolic acid, lactic acid, gluconic acids, glutaric acid and their salts.

In addition to the carboxylic compounds as stabilizing agents, small but effective amount of poly hydroxy compounds also can be used as stabilizers in amounts ranging from about 0.001 to 2.0 and preferably from 0.01 to 1.0 mole per liter. The compounds include the trihydric compounds e.g. glycerol and the dihydric ether alcohols e.g. glycol ethers including alkylene glycol ethers, e.g. triethylene glycol ethers, propylene glycol ethers, tripropyleneglycol ethers, diethyleneglycol ether. Other glycols include some of the lower molecular weight compounds such as ethylene glycol, propylene glycol, butylene glycol, cyclohexanol, and the water-soluble poly (oxyalkylene glycols) e.g. the poly-(oxyethylene) or poly-(oxypropylene glycols), having lower molecular weights ranging up to about 1000 may be employed to promote stability and dispersibility of solids in the coating bath or acid solutions. Other known di- and trihydric aliphatic alcohols include the water soluble lower alkanols, such as the di- and tri-hydric alkanols containing up to twelve carbon atoms. This class of di- and trihydric lower alkanols can include glycols containing up to ten carbon atoms in the alkylene group e.g. trimethylene glycol, and the polyglycols, such as diethylene glycol, triethylene glycol, tetraethylene glycol, dipropylene glycol, tripropylene glycol, dibutylene glycol, tributylene glycol, and other polyalkylene glycols wherein the alkylene radical contains from two to eight carbon atoms and preferably from two to four carbon atoms. Combinations or mixtures of the carboxylic and polyhydroxy stabilizing compounds may be used in the acidic solution in any ratio.

In addition to the polyhydroxy and carboxylic stabilizing compounds, the acidic aqueous solutions may contain small but effective amounts of from 0.0 to 24 grams e.g. 0.01 to 12 grams per liter of solution of at least one fluorometallic compound including compounds such as hexafluorotitanate, heptafluorotantalate, tetrafluoroborate, hexafluorosilicate and the like.

In preparing the acidic solutions of this invention, known water soluble surfactants can be added to the trivalent chromium solutions in amounts ranging from about 0 to 20 grams per liter and preferably about 5.0 to 10 grams or 1.0 to 5.0 grams per liter. The surfactants are added to the aqueous solution to provide better wetting properties by lowering the surface tension thereby insuring complete coverage, and a more uniform film on the metal substrates. The surfactants include at least one water soluble compound selected from the group consisting of non-ionic, anionic, and cationic surfactants. Some of the better known water soluble surfactants include the monocarboxylimidoazoline, alkylsulfate sodium salts (DUPONOL®), ethoxylated or propoxylated alkylphenol (IGEPAL®), alkylsulfonamides, alkaryl sulfonates, palmiticalkanol amides (CENTROL®), octylphenyl polyethoxy ethanol (TRITON®), sorbitan monopalmitate (SPAN®), dodecylphenyl polyethyleneglycol ether (TERGITROL®), alkyl pyrrolidones, polyalkoxylated fatty acid esters, alkylbenzene sulfonates and mixtures thereof. Other known water soluble surfactants include, for example, the nonylphenol ethoxylates, and adducts of ethylene oxide with fatty amines; see the publication: “Surfactants and Detersive Systems”, published by John Wiley & Sops in Kirk-Othmer's Encyclopedia of Chemical Technology, 3^{rd} Ed.

When large surfaces do not permit immersion or where vertical surfaces are to be sprayed, thickening agents can be added to retain the aqueous solution on the surface for sufficient contact time. The thickeners employed are known inorganic and preferably the organic water soluble thickeners added to the trivalent chromium solutions in effective amounts e.g. at sufficient concentrations ranging from about 0 to 20 grams per liter and preferably 0.5 to 10 grams or 1.0 to 5.0 grams per liter of the acidic solution. Specific examples of some preferred thickeners include the cellulose compounds, e.g. hydroxypropyl cellulose (e.g. Klucel), ethyl cellulose, hydroxyethyl cellulose, hydroxymethyl cellulose, or methyl cellulose and mixtures thereof. Other water soluble inorganic thickeners include colloidal silica, clays such as bentonite, starches, gum arabic, tragacanth, agar and various combinations.

After preparing the metal substrate surface to be coated via conventional techniques, the solution can be applied via immersion, spray or wipe-on techniques. The TCP solutions of this invention can be used at elevated temperatures ranging up to 120° F. or higher e.g. up to 200° F. and optimally applied via immersion to further improve the corrosion resistance of the coatings. Solution dwell time ranges from about 1 to 60 minutes, and preferably 1.0 to 40 or 1.0 to 10 minutes at about 80° F. or higher. After dwelling, the remaining solution is then thoroughly rinsed from the substrate with tap or deionized water. No additional chemical manipulations of the deposited films are necessary for excellent performance. However, an application of a strong oxidizing solution can yield a film having additional corrosion resistance. The additional corrosion resistance is presumed to be due to the formation of hexavalent chromium in the film derived from the trivalent chromium. The aqueous solutions may be sprayed from a spray tank apparatus designed to replace immersion tanks.

While this invention has been described by a number of specific examples, it is obvious that there are other variations and modifications which can be made without departing from the spirit and scope of the invention as particularly set forth in the appended claims.

The invention claimed:

1. Process for coating metal substrates to improve the corrosion protection and adhesion bonding strength which comprises treating the metal substrates with effective amounts of an acidic aqueous solution having a pH ranging from about 1.0 to 5.5; said acidic aqueous solution comprising, per liter of solution, from about 0.01 to 100 grams of at least one trivalent chromium compound, from about 0.01 to 24 grams of at least one fluorozirconate, from about 0.0 to 20 grams of divalent zinc compounds, from about 0.0 to 20 grams of surfactants, from about 0.0 to 20 grams of thickeners, and effective amounts of at least one stabilizing compound selected from the group consisting of polyhydroxy compounds, carboxylic compounds and mixtures of the polyhydroxy and carboxylic compounds.

2. The process of claim 1 wherein the metal substrates have a pre-existing metal coating thereon.

3. The process of claim 2 wherein the pre-existing metal coated substrate is anodized aluminum.

4. The process of claim 2 wherein the pre-existing metal coated substrate is a phosphate coating.

5. The process of claim 1 wherein the metal substrate is an aluminum alloy.

6. The process of claim 1 wherein the metal substrate is an iron alloy.

7. The process of claim 1 wherein the carboxylic compound is a hydroxy-carboxylic compound.

8. The process of claim 7 wherein the hydroxy-carboxylic compound is citric acid and the water soluble salts thereof.

9. The process of claim 7 wherein the hydroxy-carboxylic compound is glycolic acid and the water soluble salts thereof.

10. The process of claim 7 wherein the hydroxy-carboxylic compound is gluconic acid and the water soluble salts thereof.

11. The process of claim 1 wherein the carboxylic compound is formic acid and the water soluble salts thereof.

12. The process of claim 1 wherein the carboxylic compound is propionic acid and the water soluble salts thereof.

13. The process of claim 1 wherein the acidic aqueous solution contains from about 0.001 to 1.0 mole per liter of formic acid.

14. The process of claim 1 wherein the acidic aqueous solution contains from about 0.001 to 2.0 moles per liter of the stabilizing compounds.

15. The process of claim 14 wherein the stabilizing compound is glycerol.

16. The process of claim 14 wherein the stabilizing compound is a carboxylic compound having more than one functional carboxylic group per molecule.

17. Compositions for coating metal substrates to improve the corrosion protection and adhesion bonding strength of said metal substrates which comprise an acidic aqueous solution having a pH ranging from about 1.0 to 5.5 and per liter of said solution from about 0.01 to 100 grams of at least one trivalent chromium compound, from about 0.01 to 24 grams of at least one fluorozirconate, from about 0.0 to 20 grams of divalent zinc compounds, from about 0.0 to 20 grams of surfactants, from about 0.0 to 20 grams of thickeners, and effective amounts of at least one stabilizing compound selected from the group consisting of polyhydroxy compounds, carboxylic compounds and mixtures of polyhydroxy and carboxylic compounds.

18. The composition of claim 17 wherein the stabilizing compound is a carboxylic compound have more than one functional carboxylic group per molecule.

19. The composition of claim 17 wherein the carboxylic compound is a hydroxy-carboxylic acid and the water soluble salts thereof.

20. The composition of claim 19 wherein the hydroxy-carboxylic compound is citric acid and the water soluble salts thereof.

21. The composition of claim 19 wherein the hydroxy-carboxylic compound is glycolic acid and the water soluble salts thereof.

22. The composition of claim 19 wherein the hydroxy-carboxylic compound is lactic acid and the water soluble salts thereof.

23. The composition of claim 17 wherein the carboxylic compound is formic acid and the water soluble salts thereof.

24. The composition of claim 17 wherein the carboxylic compound is propionic acid and the water soluble salts thereof.

25. The composition of claim 17 wherein the polyhydroxy compound is glycerol and the carboxylic compound is a lower molecular weight carboxylic acid and the water soluble salts thereof.

26. The composition of claim 17 wherein the stabilizing compound is a mixture of a lower molecular weight carboxylic acid and a polyhydroxy compound.

27. The composition of claim 17 wherein the stabilizing compound is a low molecular weight polyhydroxy compound.

28. The composition of claim 27 wherein the polyhydroxy compound is glycerol.

29. The composition of claim 17 wherein the zinc compound is a water soluble zinc salt present in the acidic aqueous solution in an amount ranging from about 0.5 to 2.0 grams.

30. The composition of claim 29 wherein at least one polyhydroxy compound is glycerol.

31. The composition of claim 29 wherein the polyhydroxy compound is a polyalkylene glycol.

32. The composition of claim 17 wherein the pH ranges from about 2.5 to 4.5, the trivalent chromium compound ranges from about 0.01 to 22 grams, the fluorozirconate is hexafluorozirconate ranging from about 0.01 to 12 grams, and the stabilizing compounds range from about 0.001 to 1.0 mole per liter.

33. The composition of claim 32 wherein the stabilizing compound is a lower molecular weight carboxylic acid and the water soluble salts.

34. The composition of claim 32 wherein the stabilizing compound is a polyhydroxy compound.

35. The composition of claim 32 wherein the zinc compound ranges from about 0.001 to 10 grams.

36. The composition of claim 32 wherein the thickeners and/or the surfactants range from about 1.0 to 5.0 grams.

37. The composition of claim 32 wherein the zinc compound is present in the aqueous solution in amounts ranging from about 0.5 to 2.0 grams per liter of solution.

38. The composition of claim 17 wherein the acetic aqueous solution contains from about 0.01 to 12 grams per liter of at least one fluorometallic compound selected from the group consisting of fluorotitanates, fluorotantalates, fluoroborates, fluorosilicates and mixtures thereof.

39. The composition of claim 38 wherein the fluorometallic compound is fluoroborate and the fluorozirconate is hexafluorozirconate.

40. The composition of claim 38 wherein the fluorometallic compound is fluorosilicate and the fluorozirconate is hexafluorozirconate.
